(19) United States
(12) Patent Application Publication
(10) Pub. No.: US 2012/0180797 A1
(43) Pub. Date: Jul. 19, 2012

(54) MODULAR PEDIATRIC PLATFORM

(75) Inventors: Nick Deeter, Warsaw, IN (US); Michael F. Maguire, Santa Barbara, CA (US); Shawn Placie, Ft. Wayne, IN (US); Jeff Minaudo, South Bend, IN (US)

(73) Assignee: ORTHOPEDIATRICS CORPORATION, Warsaw, IN (US)

(21) Appl. No.: 13/217,393

(22) Filed: Aug. 25, 2011

Related U.S. Application Data
(63) Continuation of application No. PCT/US10/25465, filed on Feb. 25, 2010.

(51) Int. Cl. A61G 15/00

(52) U.S. Cl. 128/845

(57) ABSTRACT

A modular table is described for supporting a patient during application of a spica cast. In various embodiments, the table is modular, having a support for the patient's upper body and a separate support for the patient's lower body. The supports have coupling members that interface with existing examination or operating tables, or with additional members attached thereto. The coupling members may be placed into features shaped to receive them in one or more spaced-apart positions, or in other embodiments may slide through T-shaped slots or tracks that guide relative alignment of the supports. The tracks for the two supports may be the same or different; straight or curved; and parallel, perpendicular, or skew. Additional fixtures attach to the table or additional members to assist in applying traction to the patient during the application.

### REFERENCE TO RELATED APPLICATION

This application is a continuation of, and claims priority to, PCT Patent Application No. PCT/US 10/25465, filed Feb. 25, 2010, with title “Table for Placement of a Spica Cast,” pending. The entire disclosure in that application is incorporated herein by reference as if fully set forth.

### FIELD

The present invention pertains to a table utilized during medical procedures, and in particular to a table to be used during preparation of a spica cast.

### BACKGROUND

Although the application of hip spica casts in the management of fractures of the femur in children has been a standard modality of treatment since the invention of plaster, the early application as a definitive method of fracture treatment has only recently been driven in popularity by the economics of health care. The traditional method of treating fractured femurs prior to the 1990's in most pediatric centers was the application of traction followed by a hip spica cast once the fracture had consolidated with callus.

As health care costs escalated in the 1980's and 1990's, innovative methods were used to decrease the prolonged hospitalization required by traction techniques, even though this type of management of a fractured femur is still very effective in obtaining a good long-term result and should be considered for patients in whom other modalities of treatment are inappropriate due to the type of trauma or other complicating factors regarding the fracture. One such innovative method is the application of hip spica casting for fractured femurs in children. Some of the advantages of early hip spica casting in pediatric patients include: (1) decreased hospital stay and costs; (2) avoidance of complications of skin and skeletal traction; (3) decreased radiographic exams; and (4) rapid return of child to the family environment.

A hip spica includes the trunk of the body and one or more legs. A hip spica which covers only one leg to the ankle or foot may be referred to as a single hip spica, while one which covers both legs is called a double hip spica. A one-and-a-half hip spica encases one leg to the ankle or foot and the other to just above the knee. The extent to which the hip spica covers the trunk depends greatly on the injury and the surgeon. The spica may extend only to the navel, allowing mobility of the spine and the possibility of walking with the aid of crutches, or may extend to the rib cage or even to the armpits in some rare cases. Hip spicas are used for congenital hip dislocations, and then mostly while the child is still an infant.

### BRIEF DESCRIPTION OF THE DRAWINGS

FIG. 1 is a side schematic drawing of an apparatus according to one embodiment of the present invention.

FIG. 2 is a frontal, right side, top perspective drawing of an apparatus according to another embodiment of the present invention.

FIG. 3 is a frontal, right side, top perspective drawing of an apparatus according to still another embodiment of the present invention.

FIG. 4 is a frontal, right side, top perspective drawing of an apparatus according to yet another embodiment of the present invention.

FIG. 5 is a frontal, right side, top perspective drawing of an apparatus according to yet another embodiment of the present invention.

FIG. 6 is a frontal, right side, top perspective drawing of an apparatus according to yet another embodiment of the present invention.

FIG. 7 is a frontal, right side, top perspective drawing of an apparatus according to yet another embodiment of the present invention.

FIG. 8 is a frontal, left side, top perspective drawing of an apparatus according to still another embodiment of the present invention.

FIG. 9 is a frontal, left side, top perspective drawing of a support in the embodiment of FIG. 8.

FIG. 10 is a frontal, left side, top perspective drawing of an upper body support in the embodiment of FIG. 8.

FIG. 11 is a rear, right side, top perspective drawing of an upper body support in the embodiment of FIG. 8.

FIG. 12 is a frontal, left side, top perspective drawing of the embodiment of FIG. 8.

FIG. 13 is a frontal, right side, top perspective drawing of a foot pocket in the embodiment of FIG. 8.

FIG. 14 is a frontal, right side, top perspective drawing of a foot pocket in the embodiment of FIG. 8 in an alternative configuration.

FIGS. 15-18 are perspective views of alternative, interchangeable platforms for use in another alternative embodiment.

### DESCRIPTION

For the purpose of promoting an understanding of the principles of the invention, reference will now be made to the embodiments illustrated in the drawings, and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an element, step, or composition that must be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 or 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, etc.) may be stated herein, such specific quantities are presented as examples only. Further, discussion pertaining to a specific composition of matter is by way of example only, and does not limit the applicability of other species of that composition, nor does it limit the applicability of other compositions unrelated to the cited composition.

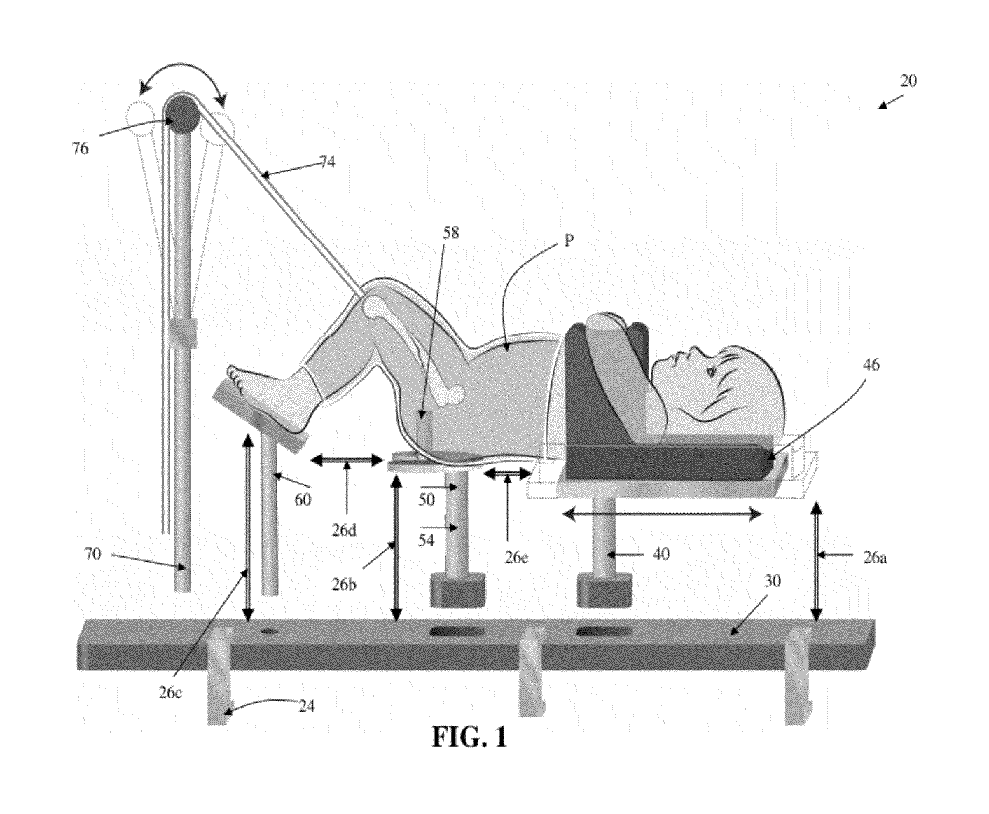

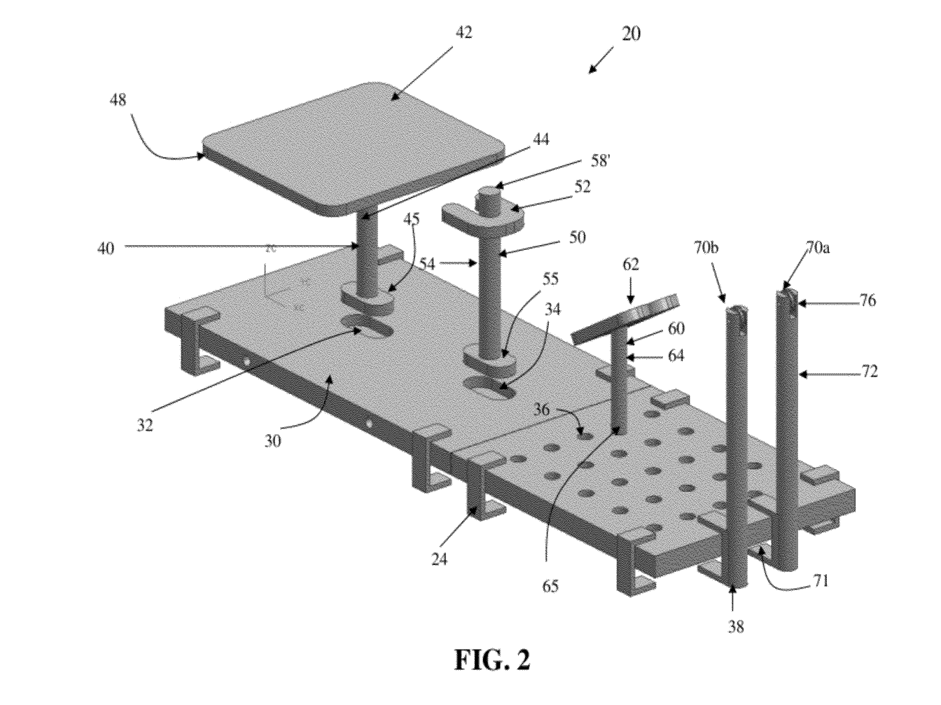

FIGS. 1 and 2 depict an apparatus 20 according to one embodiment of the present invention. Table assembly 20 includes a support table 30 that provides relative placement of an upper body support 40, a lower body support 50, a foot support 60, and a traction device 70. In some embodiments, support table 30 is positioned on a supporting surface (not shown) such as an operating table or a gurney by a plurality of attachment brackets 24 extending around the periphery of support table 30. However, in yet other embodiments, support 30 is integral with a table or gurney, and does not need attachment brackets. Preferably, apparatus 20 is fabricated from material that is radiolucent so as to not impact the use of X-rays. Various embodiments are constructed in various ways, as discussed further herein.

As best seen in FIG. 1, a patient P such as a pediatric patient is supported in large measure by upper body support 40 and lower body support 50. Upper body support 40 includes a platform 42 that is supported by a column 44. Column 44 includes a coupling 45 that is received within a complementary-shaped coupling feature 32 within main support 30 (as best seen in FIG. 2). Preferably, the patient P rests her body on a cushion 46 supported by platform 42. In some embodiments, platform 42 includes a warming device 48, such as a resistive electronic heater.

Further support for patient P is provided by a lower body support 50. Support 50 includes a platform 52, on which the lower back and upper back side of the legs of the patient P are placed. A support column 54 supports platform 50 at a height above the surface of table 30. Support column 54 is located on table 30 by the fastening of a coupling 55 to a complementary-shaped feature 34. A projection 58 extends upward from platform 52. Projection 58 is placed between the legs of patient P, and limits the movement of patient P in the direction toward traction device 70. As shown in FIG. 1, projection 58 can be longitudinally offset from column 54. However, as shown in FIG. 2, projection 58′ can also be an extension of column 54.

The feet of the patient P are supported by a foot support 60 spaced apart from lower body support 50. Support 60 includes a platform 62 for supporting one or both feet. Platform 62 is spaced above the surface of table 30 by a column 64. Column 64 includes a coupling 65 on one end that mates with a complementary-shaped feature 36 of table 30. In some embodiments, platform 62 is a single, unitary platform having a width great enough to support both feet of patient P. In yet other embodiments, apparatus 20 includes a pair of foot supports 60, one each for the right and left feet. As best seen in FIG. 2, in one embodiment table 30 includes a plurality of coupling features 36 to permit relatively quick and easy placement of foot support 60. In some embodiments, woven nylon straps (or slots for attachment thereof) are included on each foot support 60 to hold the feet of patient P in position during the spica application procedure.

Apparatus 20 in some embodiments further includes one or more traction devices 70a and 70b for placing a load on patient P. In one embodiment, traction device 70 includes a tower 72 having a pulley 76 located at the top. Referring to FIG. 1, a tether 74 can be applied to the leg of patient P on one end, and on the other end of tether 74, a weight or other tensioning device (not shown) is attached. Referring to FIG. 2, one or more traction device clamps 38 couple column 72 to end 71 of table 30.

Referring to FIG. 1, apparatus 20 includes three body supports (upper body support 40, lower body support 50, and foot support 60) that are spaced upwardly from the top surface table 30, and which further are spaced apart from each other. These spacing and gaps facilitate access to patient P for purposes of applying a spica cast, while at the same time supporting patient P in a manner that facilitates various procedures in an operating room. Each of the three supports are spaced upwardly from the top surface of table 30: upper support 40 being spaced upwardly by a distance 26a; lower body support 50 being upwardly spaced by a distance 26b; and foot support 60 being upwardly spaced by a distance 26c. In some embodiments, one or more of these upward spacings are adjustable. In some embodiments, in addition to or instead of adjustability, apparatus 20 includes a plurality of upper, lower, and foot supports provided in a kit, such that, for example, there are multiple foot supports 60, each having a different length for column 64.

In addition to this upward spacing, the three supports for patient P are spaced apart, and thereby provide gaps for application of the spica cast. Still referring to FIG. 1, there is a horizontal gap 26e between opposing edges of platforms 42 and 52. Similarly, there is a horizontal gap 26d between opposing edges of platforms 52 and 62. These gaps provide sufficient open space for the medical professional to apply the spica cast around the body of patient P.

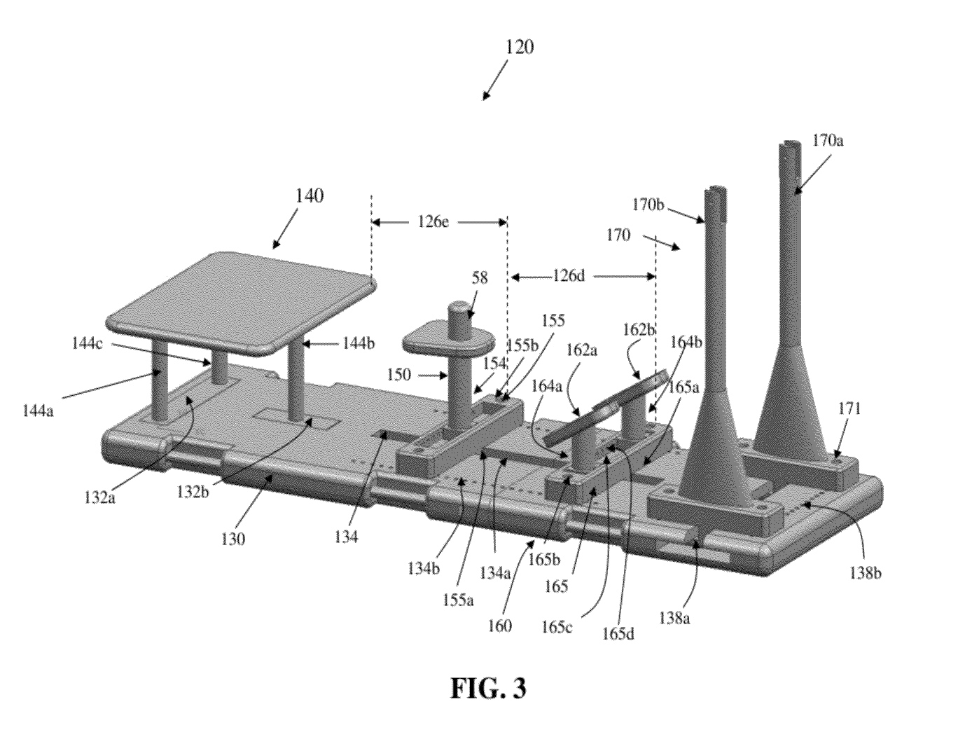

FIG. 3 shows an apparatus 120 according to another embodiment. Apparatus 120 is the same as apparatus 20, except for the differences that are shown or described here.

Apparatus 120 includes features for adjusting the distance 126d and 126e between adjacent platforms. Lower body support 150 is coupled to support table 130 in such a way that it can be moved horizontally along a longitudinal axis of support table 130. Lower body support 150 includes a coupling 155 between support column 154 and table 130 that includes one or more projections 155a that are received within a slot 134a. Projection 155a extends downwardly into slot 134a. Coupling 155 also includes a locating and fixation feature 155b that mates with a corresponding fixation feature 134b on table 130. In one embodiment, fixation features 155b include a through hole and a threaded fastener, the fastener being received within a threaded hole 134b extending laterally from either side of slot 134.

In addition, table assembly 120 includes a foot support 160 that likewise includes one or more projections 165a that extend downwardly from a coupler 165 into track 134a. In similar fashion to coupling 155, coupling 165 includes a pair of coupling features 165b that mate with a corresponding feature 134b within table 130.

By loosening of the threaded attachments 155b or 165b from the corresponding threaded hole 134b, the medical professional is able to adjust the position of supports 150 and 160 relative to upper body support 140. In addition, foot support 160 includes a pair of separate supports 162a and 162b that can move laterally within a track 165c contained within coupling 165. Coupling 165 further includes complementary features for fixing the lateral location of supports 162a and 162b. In one embodiment, coupling 165 includes a plurality of through holes 165d that permit engagement of a fastener into a corresponding threaded hole within support column 164a or 164b. The medical professional can place individual foot supports 162a and 162b in a position best suited for application of the spica cast to the particular patient P.

Traction device 170 includes towers 170a and 170b that can be moved laterally within a track 138a of support table 130. Each separate traction device includes a clamp or coupling 171 that permits fixation of the traction devices at various different lateral locations. In one embodiment, coupling 171 includes a threaded fastener and a through hole which is accepted within a threaded through hole 138b of support table 130. The medical practitioner can thereby move the separate traction devices 170a and 170b so as to best apply the traction load onto the legs of patient P as positioned by foot supports 162a and 162b.

In addition, it can be seen that in some embodiments upper body support 140 includes a plurality of columns 144a, 144b, and 144c for secure positioning of the upper body of patient P above the surface of table 130. The columns 144a, 144b, and 144c fit into front support coupling features 132a and 132b. In the illustrated embodiment, coupling feature 132a receives two columns, and coupling feature 132b receives one, though many equally acceptable configurations, attachment feature types, and support mechanisms will be used in various embodiments as will occur to those skilled in the art in view of this disclosure.

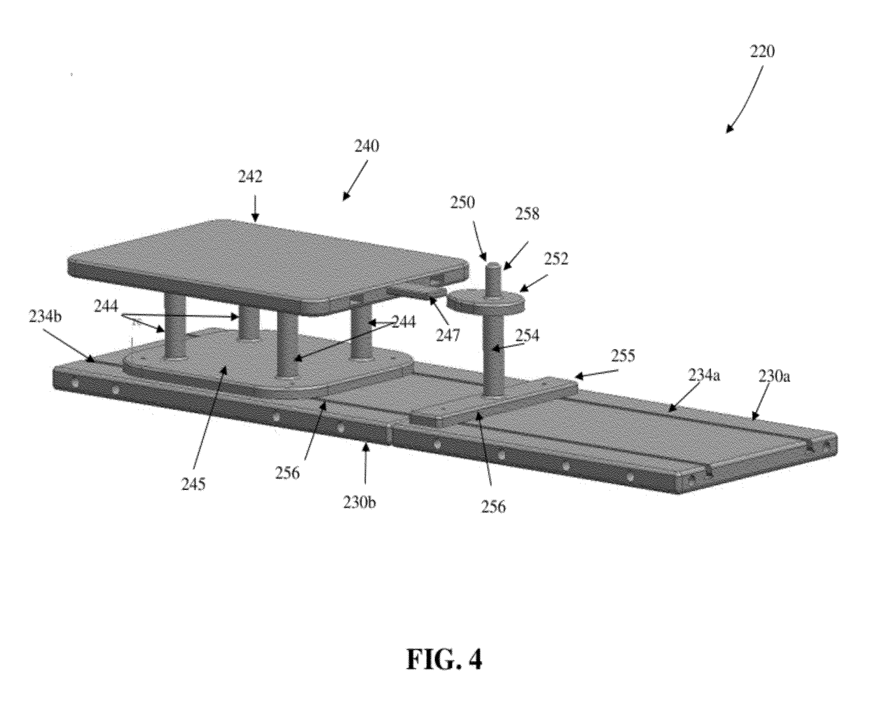

FIG. 4 shows an apparatus 220 according to another embodiment of the present invention. In this embodiment, lower body support section 250 includes platform 252, through which support column 254 extends as projection 258. Support column 254 is mounted on coupling element 255, which includes projections 256 that extend into track or slot 234a in such a way that lower body support 250 can be moved along the longitudinal axis of secondary table section 230a. This flexibility allows medical practitioners to adjust table 220 so that upper body support 240 and lower body support 250 are a desired distance apart, varying continuously from a space of zero (where center tab 247 touches platform 252) up to some maximum distance (where base platform 245 and coupling element 255 are at extreme opposite ends of their respective table sections). This adjustability allows the table to accommodate patients of different sizes in various clinical environments, and to manipulate materials around the cast and the patient P as required.

Table assembly 220 also has a main portion 230b of table 230. Main portion 230b, like secondary table section 230a, has tracks or slots 234b through which projections 256 on the bottom of base platform 245 so that upper body support structure 240 can be moved closer to and further away from lower body support structure 250 as necessary or desired. Support columns 244 are affixed to the top of base platform 245 to support platform 242, upon which patient P rests during the spica cast application procedure. Center tab 247 extends from platform 242 toward lower body support 250 to provide additional support for the upper body of patient P without extending laterally to such an extent as to impede access to the patient and the spica cast by healthcare professionals. A foot support system and/or traction system may be added to the elements shown in FIG. 4, as will occur to those skilled in the art in view of the disclosure herein.

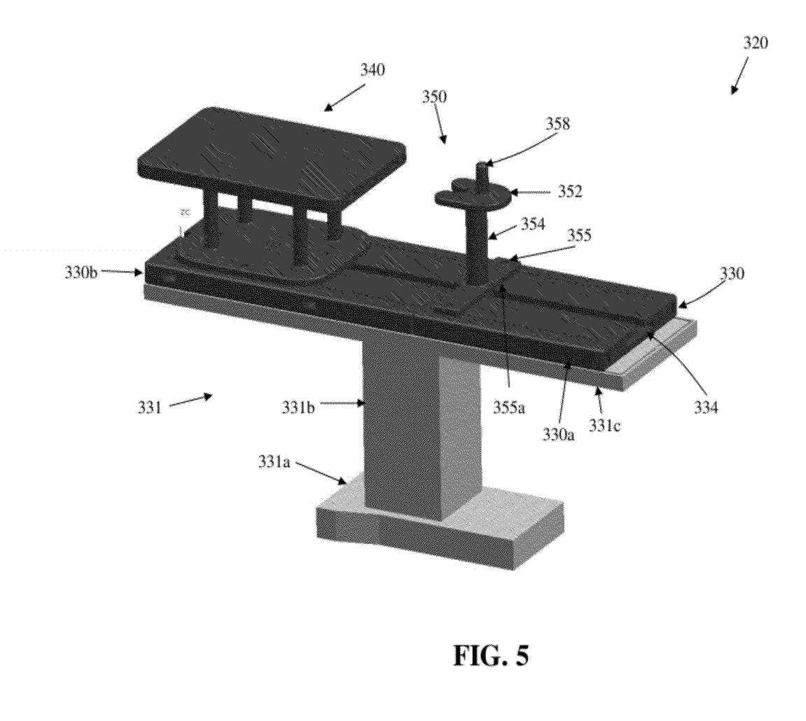

FIG. 5 illustrates yet another table assembly embodiment 320. This assembly 320 includes a pedestal 331 with base 331a, post 331b, and platform 331c. Lower body portion 330a and upper body portion 330b of main support 330 lie on and are supported by platform 331c. In some forms of this embodiment, main support 330 is permanently attached to platform 331c of pedestal 331, while in others main support 330 is removably attached to platform 331c by removable nylon straps, post-and-socket joints, or other means as will occur to those skilled in the art in view of this disclosure.

Both portions of main support 330 include a track or slot feature 334 that guides movement of upper body support assembly 340 and lower body support assembly 350. Lower body support 350 includes coupling number 355, which has projection 355a that extends into and is slidable through track or slot 334. Support column 354 extends up from coupling number 355 to support platform 352, which has a somewhat different design from platforms 52 and 252 discussed elsewhere herein. Projection 358 extends up from platform 352 to limit movement of patient P and provide a fixed reference point for table assembly 320. Upper body support 340 in this illustrated embodiment is like upper body support 240, illustrated in FIG. 4, except that it omits center tab 247.

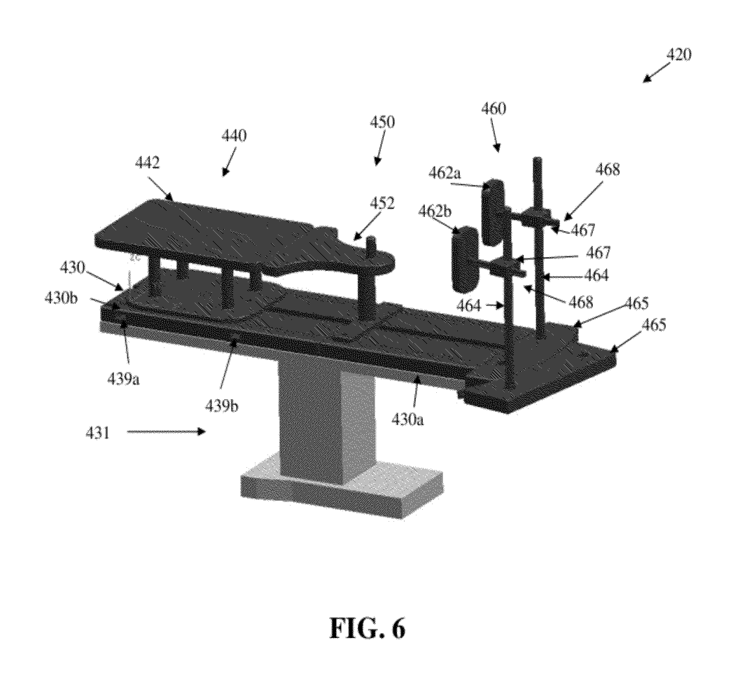

FIG. 6 illustrates table assembly 420, which includes pedestal 431, upper body support 440, lower body support 450, and foot support assembly 460. Upper body support 440 in the illustrated embodiment is similar to upper body support 340 as illustrated in FIG. 5, though alternative embodiments will occur to those skilled in the art in view of the description herein.

Lower body support 450 in FIG. 6 resembles lower body support 350 illustrated in FIG. 5, except that platform 452 has a bell shape, whereas platform 352 had a horseshoe shape. Platform 442 also has a center tab 447 (not shown) projecting from it toward lower body support 450, and in this embodiment it projects into a receiving slot 457 (not shown) in platform 452 to enhance the support for patient P at the upper end of platform 452.

Foot support assembly 460 includes coupling plates 445 that mount on lower portion 430a of main support 430 and/or to each other using a tongue-in-groove attachment mechanism (not shown). Support columns 464 extend up from coupling plates 465, and brackets 467 are slidably attached thereto. Platforms 462a and 462b for the feet of patient P include posts 468 extending from the back thereof, each through a bracket 467 and slidably, removably, and adjustably fixed into position relative thereto.

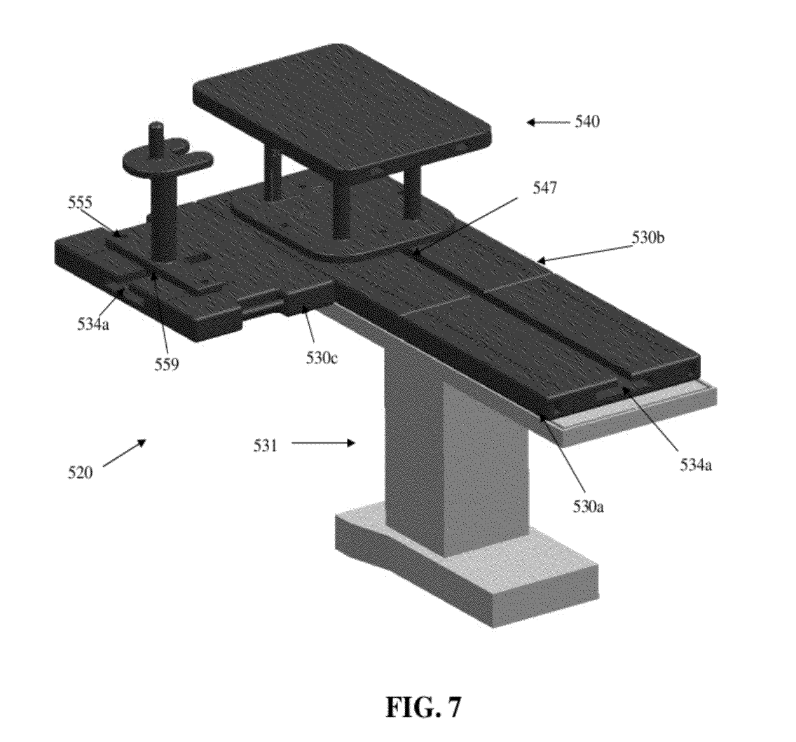

Yet another apparatus is shown in FIG. 7 as table assembly 520. Table assembly 520 includes pedestal 531, first support section 530a, second support section 530b, and third support section 530c. Each has a track or slot 534a into which projection 547 on the bottom of upper body support 540, and projection 559, extending from coupling plate 555, extend. Projections (not shown) extend from third table section 530c into extension slots 439a and 439b in the side of secondary table section 430b, which is illustrated in FIG. 6. This alternative configuration is more convenient in some circumstances.

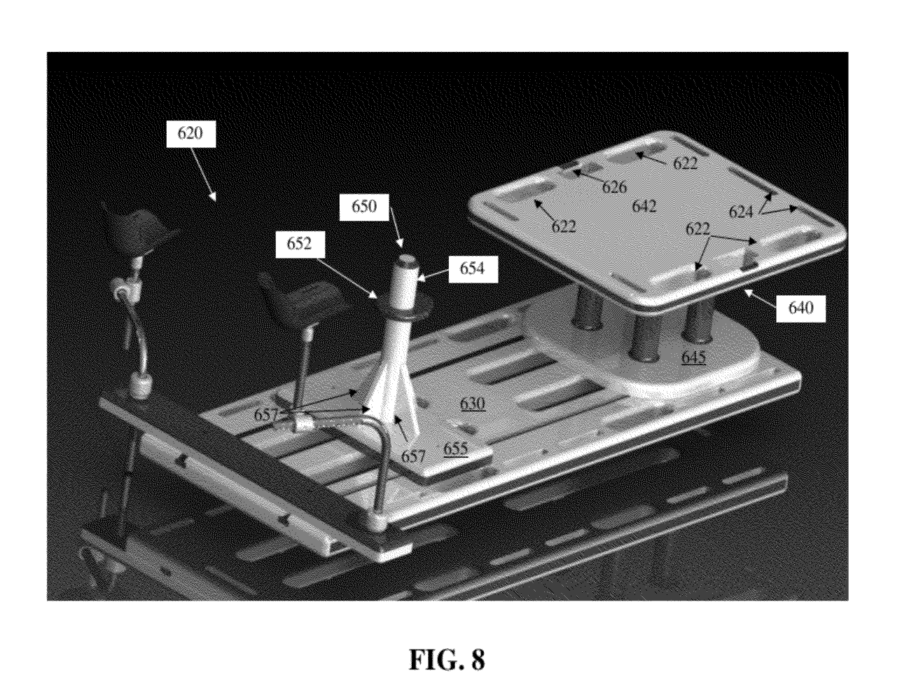

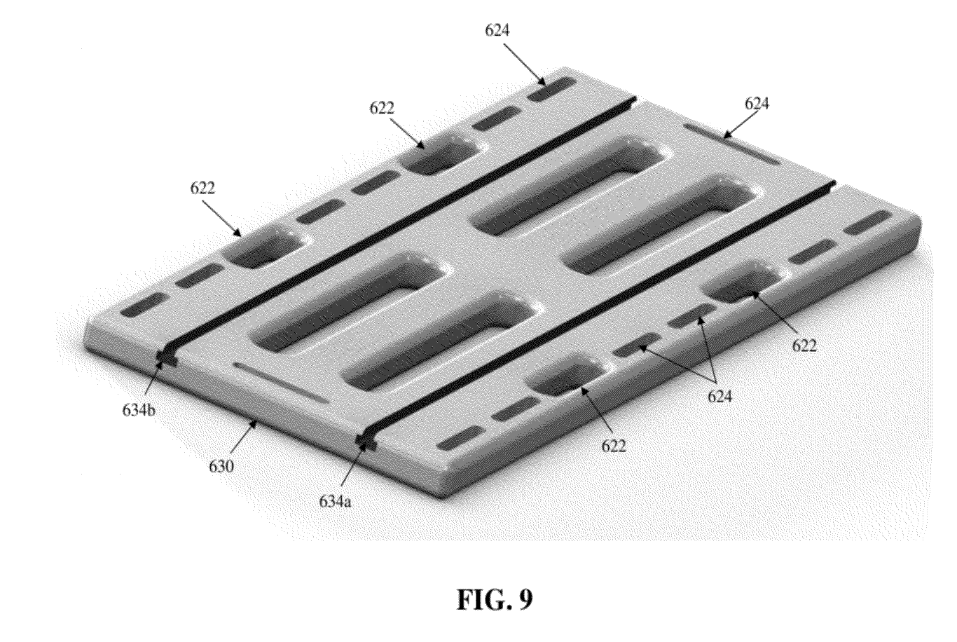

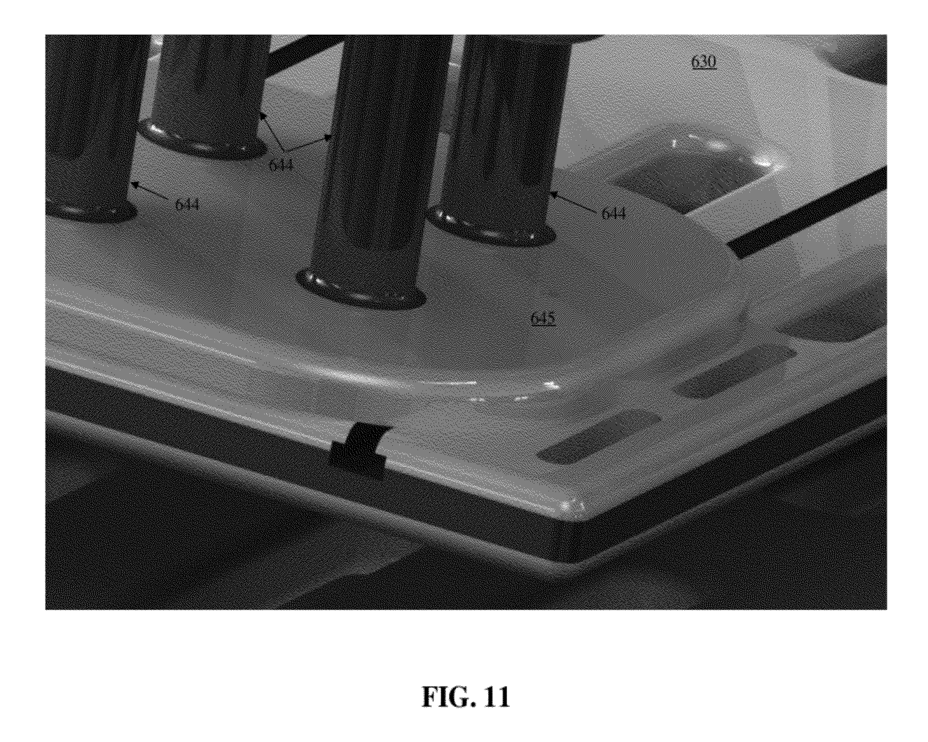

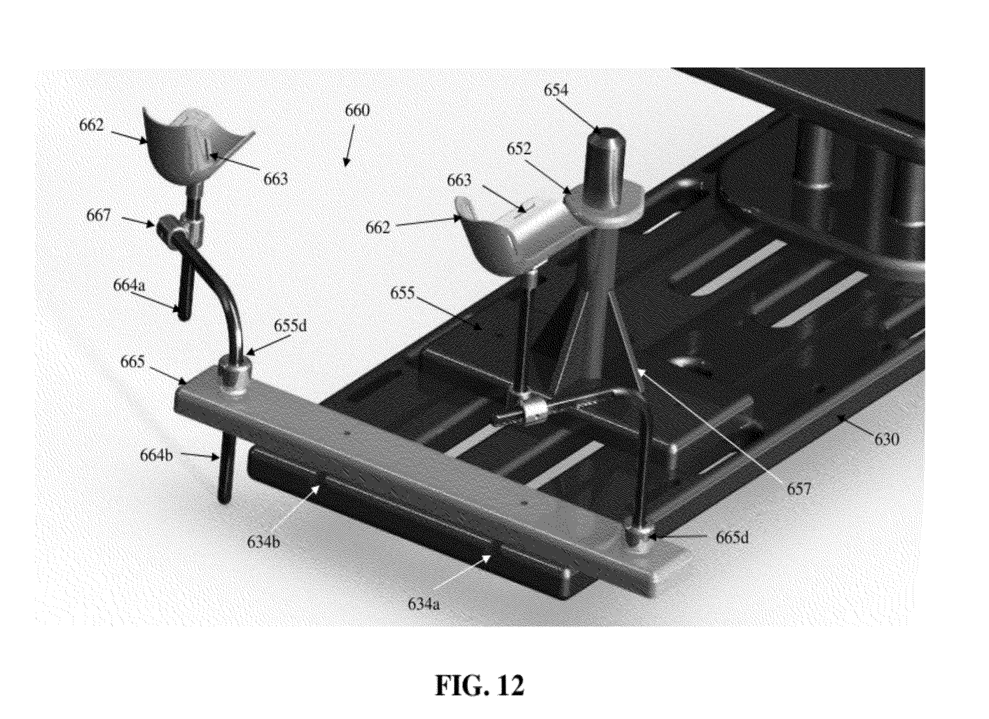

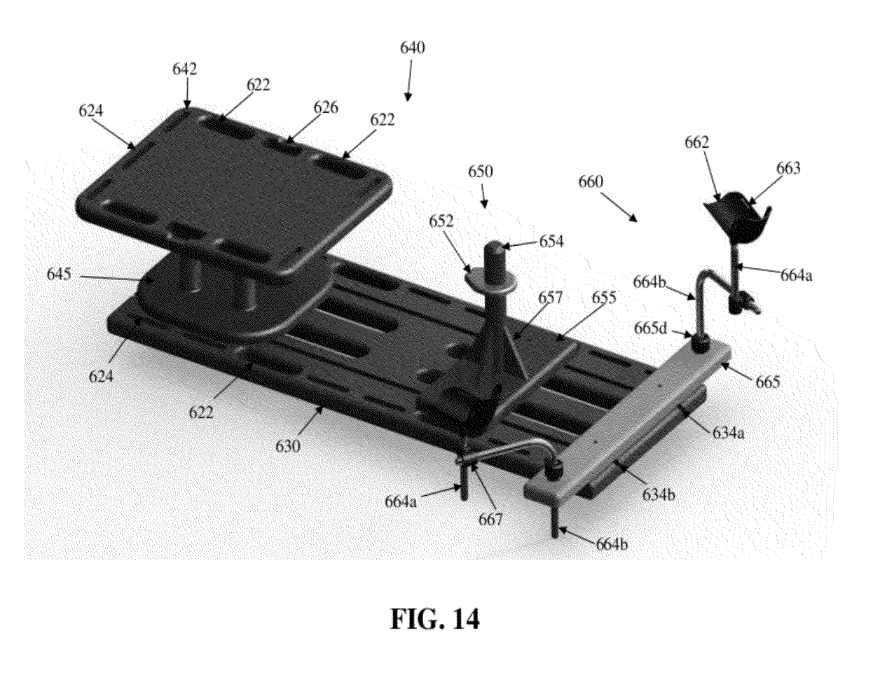

Still another apparatus is shown in FIGS. 8-14 as table assembly 620. Support section 630 has tracks or slots 634a and 634b into which projections (not shown) on the bottom of upper body support 640 and coupling plate 655 extend. Platform 642 is supported by columns 644 on top of base 645, which is connected to support platform 630 and its tracks or slots 634a and 634b.

Apparatus 620 includes handholds 622 around the perimeter of both support 630 and platform 642. These handholds 622 facilitate movement of both the apparatus 620 and its components as well as the patient P when she is positioned on platform 642.

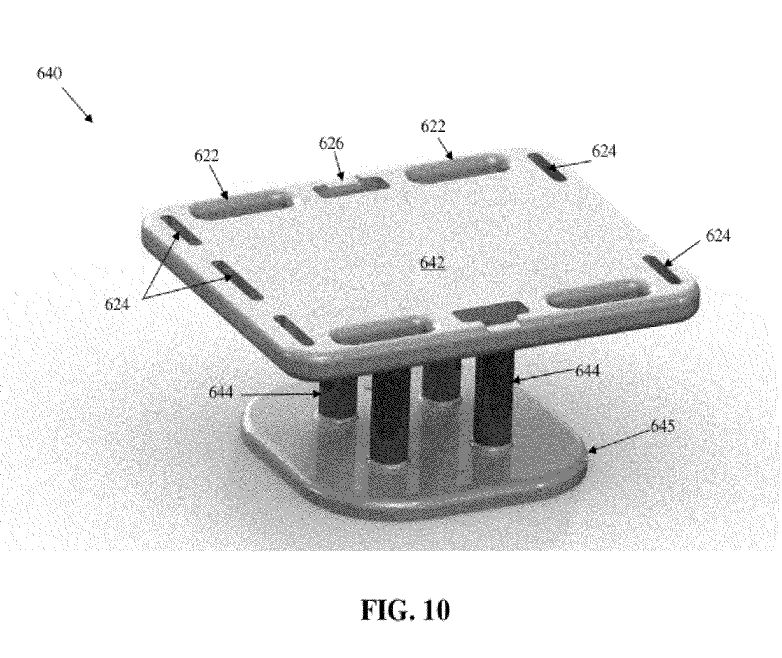

Similarly, strap holes 624 are placed along the edges of support 630 and upper body platform 642. In some embodiments, strap holes 624 are long and narrow, corresponding generally to the shape of woven nylon straps used for various purposes during use, transport, and/or storage of apparatus 620. Some slots also include a retention indentation 626 (see, for example, FIG. 10) along the edge of a handhold 622 or strap hole 624. Indentations 626 help retain straps in their places once they are affixed to the component, such as platform 642.

Lower body support 650 includes platform 652, which is held by support column 654 on plate 655. Fins 657 reinforce support column 654 in its vertical position.

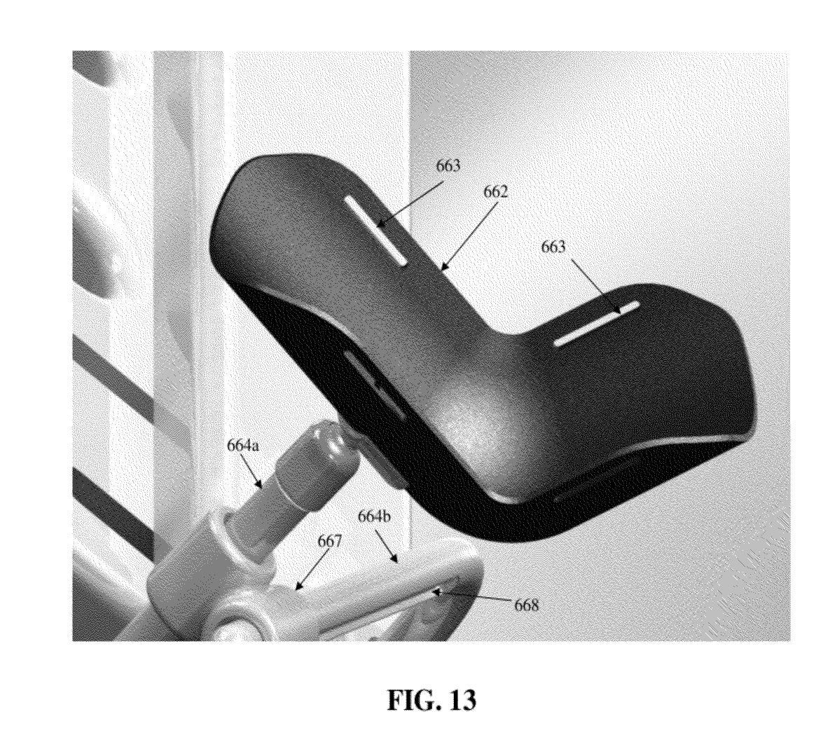

Foot supports 660 include foot pockets 662, which hold the feet of patient P during the spica application procedure. Pockets 662 include strap slots 663 for securing the foot to the pocket 662. In this embodiment, pockets 662 are each supported by a straight support member 664a, which is connected by right angle tube connector 667 to curved support member 664b. Curved support member 664b in this embodiment passes through a hole 665d in coupling plate 665, which in turn is connected to main support 630 by way of projections (not shown) that extend into slots 634a and 634b. Right angle tube connector 667 is fitted with set screws that releasably attach support members 664a and 664b in a given position. This form of attachment mechanism provides several degrees of freedom in the positioning of pockets 662 for the comfort and convenience of patient P and medical personnel. Similarly, holes 665d use set screws, releasable friction fits, or other attachment techniques to secure curved support members 664b in a particular relative position to support plate 665. In some embodiments, a groove 668 in curved support member 664b (see FIG. 13) cooperates with the set screw in right angle tube connector 667 to resist rotation of pocket 662 and straight support member 664a about the longitudinal axis of curved support member 664b.

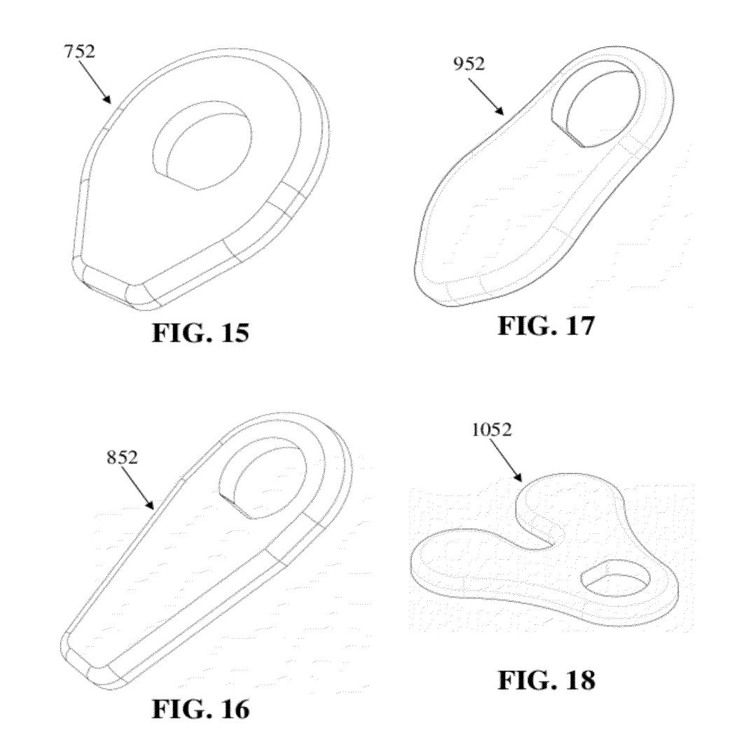

FIGS. 15-18 illustrate alternative, interchangeable support platforms 752, 852, 952, and 1052 for placement on a suitably configured post, such as support column 654 shown in FIGS. 8-14. FIG. 15 illustrates platform 752, which is approximately teardrop-shaped and defines a hole that fits snugly over a suitable support column to hold it in place. Support platform 852 in FIG. 16 provides an extended surface that reaches further away from the support column (toward the upper body support, for example) to support a heavier patient P. Similarly, FIG. 17 illustrates support platform 952, which also extends more toward the associated upper body platform, but includes a slightly wider structure, and FIG. 18 illustrates support platform 1052 that provides a still wider, lobed support surface. These alternative support surfaces can be exchanged easily according to the preference of the medical professionals performing the spica application procedure, the patient, and other preferences and circumstances.

In various embodiments, the modular platforms according to the various embodiments herein are attached to an existing examination or operating room table using means that will occur to those skilled in the art. Such attachment techniques include, but are not limited to, clamps, brackets, sliding joints, mortise and tendon joints, dovetail joints, hook-and-loop fabric strips or pads, rope, tubular nylon straps, and the like. Other attachments will occur to those skilled in the art in view of this description.

The attachment and connection features of the various embodiments described herein enable construction and use of these and many other table configurations as will occur to those skilled in the art. In some embodiments, a upper body support is easily moved along a first track in a first part of a support table, while a lower body support is easily moved along a second track in a second part of the support table. The tracks can be straight or otherwise, and may be parallel, perpendicular, skew, or otherwise.

Various embodiments are constructed of any of a variety of materials or composites using any of a variety of manufacturing methods. Some embodiments, for example, are molded using a “rotational molding” technique that will be familiar to those skilled in the art of plastic-based manufacturing. In various such embodiments, the spica tables as described herein are constructed of polyethylene (of either the high-density or low-density varieties), acrylonitrile butadiene styrene (ABS), polytetrafluoroethylene composite fabric (such as that sold under the trade name RAYDEL by Saint-Gobain Performance Plastics of Williamsville, N.Y.), polypropylene, polyvinyl chloride, nylon, polycarbonate, or polyoxymethylene (sold, for example, under the trade name DELRIN by Dupont). Other embodiments will be constructed of other materials and using different techniques as will occur to those skilled in the art.

In embodiments manufactured using a rotational molding process, the initial step of formation of the table platforms leaves voids within the pieces. In some embodiments, these voids are filled with polyurethane foam or other materials as will occur to those skilled in the art. In some embodiments, these materials resist heat transfer, thereby providing a warmer-feeling experience for the patient. Using materials having low density to fill the cavity contributes to the overall light weight of the system while supplementing its strength.

While embodiments of the invention have been illustrated and described in detail in the drawings and foregoing description, the same is to be considered as illustrative and not restrictive in character, it being understood that only a number of embodiments have been shown and described and that all changes and modifications that come within the spirit of the invention are desired to be protected.

What is claimed is:

1. A modular table for application of a spica cast to a patient, comprising:
an upper body support and a lower body support, each comprising attachment features adapted for removably attaching the supports to a medical examination table;
wherein the upper and lower body supports each comprises a support surface for supporting the upper and lower portions of a patient's body, respectively during application of a spica cast;
and the lower body support is adapted to be adjusted longitudinally relative to the upper body support to accommodate patients of different heights.

2. The modular table of claim 1, wherein the distance between the upper body support and the lower body support is continuously adjustable from a shortest distance to a longest distance.

3. The modular table of claim 2, wherein the shortest distance is substantially zero.

4. The modular table of claim 2, wherein:
the first coupling is movable along one or more tracks in the support table; and
the second coupling is movable along one or more tracks in the support table.

5. The modular table of claim 4, wherein the one or more tracks along which the first coupling moves and the one or more tracks along which the second coupling moves are different.

6. The modular table of claim 4, wherein the one or more tracks along which the first coupling moves and the one or more tracks along which the second coupling moves are the same tracks.

7. The modular table of claim 1:
further comprising a positioning member that extends through the support surface;
where the support surface is removably placed on the positioning member.

8. The modular table of claim 7 in a kit with at least one additional, interchangeable support surface, where the additional support surface has a shape selected from the set consisting of: substantially circular, horseshoe, elongated, and lobed.

9. The modular table of claim 1, wherein the upper body support and the lower body support are made from a material selected from the group consisting of polyethylene; acrylonitrile butadiene styrene; polytetrafluoroethylene composite fabric; polypropylene; polyvinyl chloride; nylon; polycarbonate; and polyoxymethylene.

10. The modular table of claim 9, wherein:
the rotational molding process leaves a cavity in the upper body support, and
the cavity is filled with polyurethane foam.

11. The modular table of claim 1, wherein the upper body support and the lower body support are made by rotational molding.

12. The modular table of claim 1, further comprising fixtures removably attached to at least one of the supports and adapted to apply traction to the patient during application of the cast.

13. A modular table on which a patient rests during application of a spica cast to the patient, comprising:
an upper body support positioned above a first coupling that is movable along one or more longitudinal tracks in a support table; and
a lower body support positioned above a second coupling that is movable along one or more longitudinal tracks in the support table, the lower body support comprising:
a support surface for supporting the lower body of a patient during application of a spica cast; and
a positioning member extending from the support surface to limit longitudinal movement of the patient during that application.

14. The modular table of claim 13, wherein the distance between the upper body support and the lower body support is continuously adjustable longitudinally from a shortest distance to a longest distance.

15. The modular table of claim 14, wherein the shortest distance is substantially zero.

16. The modular table of claim 13, wherein the upper body support and the lower body support are made from a material selected from the group consisting of polyethylene; acrylonitrile butadiene styrene; polytetrafluoroethylene composite fabric; polypropylene; polyvinyl chloride; nylon; polycarbonate; and polyoxymethylene.

17. The modular table of claim 16, wherein:
the upper body support is made using a rotational molding process,
the rotational molding process leaves a cavity in the upper body support, and
the cavity is filled with polyurethane foam.

18. The modular table of claim 13, wherein the upper body support and the lower body support are made by rotational molding.

19. The modular table of claim 13, wherein the support table comprises:
a first segment defining the one or more tracks along which the first coupling moves; and
a second segment defining the one or more tracks along which the second coupling moves;
and wherein the first segment and second segment are not permanently attached to each other.

20. The modular table of claim 13, wherein:
the first coupling that is movable along two or more tracks in the support table; and
the second coupling that is movable along two or more tracks in the support table.

21. The modular table of claim 20, wherein the one or more tracks along which the first coupling moves and the one or more tracks along which the second coupling moves are different.

22. The modular table of claim 20, wherein the one or more tracks along which the first coupling moves and the one or more tracks along which the second coupling moves are the same.

23. The modular table of claim 13, wherein:
the positioning member extends through the support surface; and
the support surface is removably placed on the positioning member.

24. The modular table of claim 23 in a kit with at least one additional, interchangeable support surface, where the additional support surface has a shape selected from the shape set consisting of: circular, horseshoe, long-and-narrow, and lobed.
